(19) United States
(12) Patent Application Publication
(10) Pub. No.: US 2007/0275583 A1
(43) Pub. Date: Nov. 29, 2007

(54) COMMUNICATION CABLING WITH SHIELDING SEPARATOR SYSTEM AND METHOD

(75) Inventors: Patrick S. McNutt, Carnation, WA (US); Bryan L. Sparrowhawk, Monroe, WA (US); Franklin C. Marti, Clinton, WA (US)

Correspondence Address: DAVIS WRIGHT TREMAINE, LLP, 1201 Third Avenue, Suite 2200, SEATTLE, WA, 98101-3045, US

(73) Assignee: LEVITON MANUFACTURING CO., INC., Little Neck, NY (US)

(21) Appl. No.: 11/750,310

(22) Filed: May 17, 2007

Related U.S. Application Data
(60) Provisional application No. 60/800,958, filed on May 17, 2006.

(51) Int. Cl. H01R 13/02

(52) U.S. Cl. 439/225

(57) ABSTRACT

A communication cabling includes a shielding separator having an elongated center member extending along a dimensional length, and a plurality of elongated dividing members each extending along the dimensional length and extending from the elongated center member. The dividing members may have at least a portion being of an electrically conductive material and others may have conductive material layers adjacent thereto.

### CROSS REFERENCE TO RELATED APPLICATION

This application claims priority benefit of provisional application Serial No. 60/800,958 filed May 17, 2006, the content of which is incorporated in its entirety.

### BACKGROUND OF THE INVENTION

1. Field of the Invention

The present invention is directed generally to communication cabling.

2. Description of the Related Art

Communication cabling typically contains multiple wires dedicated to different circuits and devices. For instance, a communication cable can have multiple pairs of wires each pair being used for different communication functions. In order to reduce signal interference from occurring between these wire pairs, conventional approaches include wrapping the wire pairs with metal foil or wire braid, which unfortunately can involve additional assembly, material costs, and cable stiffness.

### BRIEF DESCRIPTION OF THE SEVERAL VIEWS OF THE DRAWING(S)

FIG. 1 is a sectional perspective view of a portion of a communication cabling system having a first implementation of a shielding separator.

FIG. 2 is a cross-sectional view of the communication cabling system having the first implementation of the shielding separator taken along the 2-2 line of FIG. 1.

FIG. 3 is a side elevational view of a section of the first implementation of the shielding separator of FIG. 1.

FIG. 4 is a cross-sectional view of a communication cabling system having a second implementation of a shielding separator.

FIG. 5 is a side elevational sectional view of a section of the second implementation of the shielding separator of FIG. 4.

FIG. 6 is a perspective view of a section of a third implementation of a shielding separator.

FIG. 7 is a cross-sectional view of a communication cabling system having the third implementation of the shielding separator showing the shielding separator cross-sectioned along the 7-7 line of FIG. 6.

FIG. 8 is a cross-sectional view of the communication cabling system having the third implementation of the shielding separator showing the shielding separator cross-sectioned along the 8-8 line of FIG. 6.

FIG. 9 is a cross-sectional view of a communication cabling system having a fourth implementation of the shielding separator.

FIG. 10 is a side elevational sectional view of a section of the fourth implementation of the shielding separator.

FIG. 11 is a perspective view of a connector having a section of a shielding separator extending therefrom.

### DETAILED DESCRIPTION OF THE INVENTION

As will be discussed in greater detail herein, a cabling system has a shielding separator having potions of conductive plastic to shield wire pairs of a communication cabling from one another to reduce possible signal interference between the wire pairs. Implementations of the shielding separator depicted in the drawings and described below have an elongated center member with four elongated members extending therefrom to form an elongated cross or “X” structure when viewed in cross-section transverse.

Various implementations depict distribute conductive plastic material in various locations of the elongated “X” structure as further described below. Although the implementations have taken the form of an elongated “X” structure to shield four wire pairs from one another, other implementations can have other shapes either to also shield four wire pairs or to shield another number of wire pairs such as six wire pairs, etc.

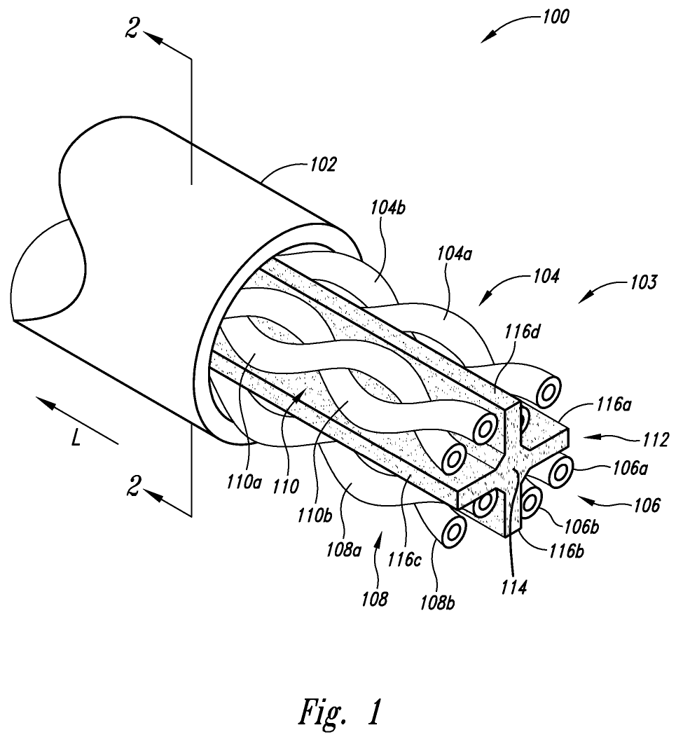

A communication cabling system 100 having a length dimension, L, is shown in FIG. 1 to include a sheathing 102 containing four wire pairs 103 comprising a first wire pair 104 having a first wire 104a and a second wire 104b, a second wire pair 106 having a first wire 106a and a second wire 106b, a third wire pair 108 having a first wire 108a and a second wire 108b, and a fourth wire pair 110 having a first wire 110a and a second wire 110b. The four wire pairs 103 are physically divided from one another by a shielding separator 112 that extends the length dimension, L, of the cabling system 100 along with the four wire pairs.

The shielding separator 112 includes an elongated center member 114 extending along the dimensional length, L. Radially extending outward from the center member 114 are four elongated dividing members 116 including a first elongated divider 116a that separates the first wire pair 104 from the second wire pair 106, a second elongated divider 116b that separates the second wire pair 106 from the third wire pair 108, a third elongated divider 116c that separates the third wire pair 108 from the fourth wire pair 110, and a fourth elongated divider 116d that separates the fourth wire pair 110 from the first wire pair 104.

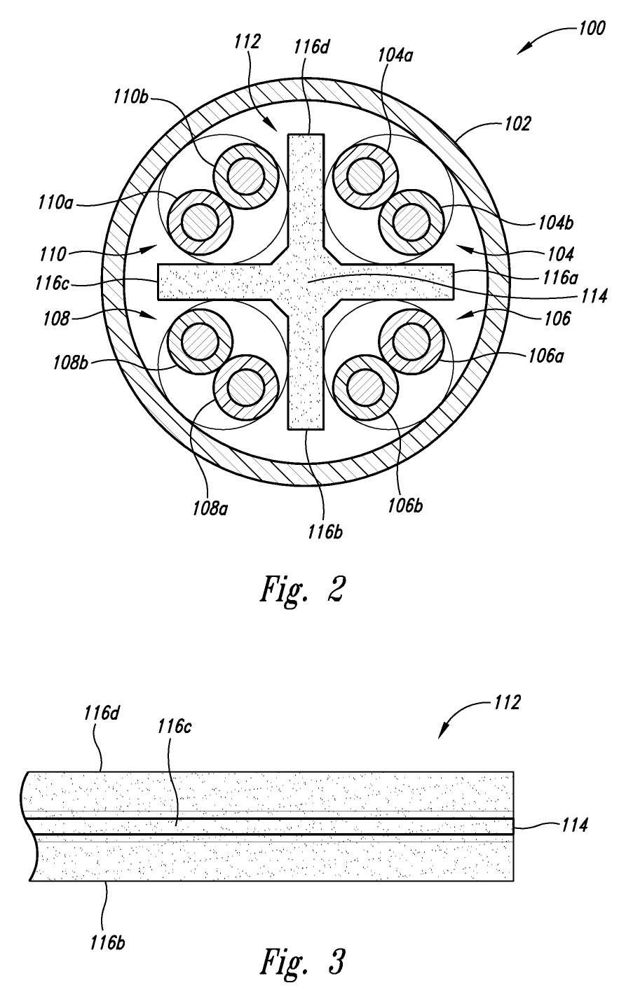

A first implementation of the shielding separator 112 is shown in FIGS. 1-3 with the dividing numbers 116 extending longitudinally along the elongated center member 114 and formed integral therewith, with each dividing member projecting laterally outward from the elongated center member. The shielding separator 112 has a uniform material construction. All along the dimensional length, L, the elongated center member 114 and the elongated dividing members 116, that can be co-extruded, are made from electromagnetic shielding material (as indicated in the Figures by stippled marking) that, among other things, greatly reduces radio frequency waves from passing therethrough. For instance, in the first implementation, the shielding separator 112 can be of a conductive plastic material such as made from an extruded plastic that is impregnated with metal fibers or other electrically conductive material.

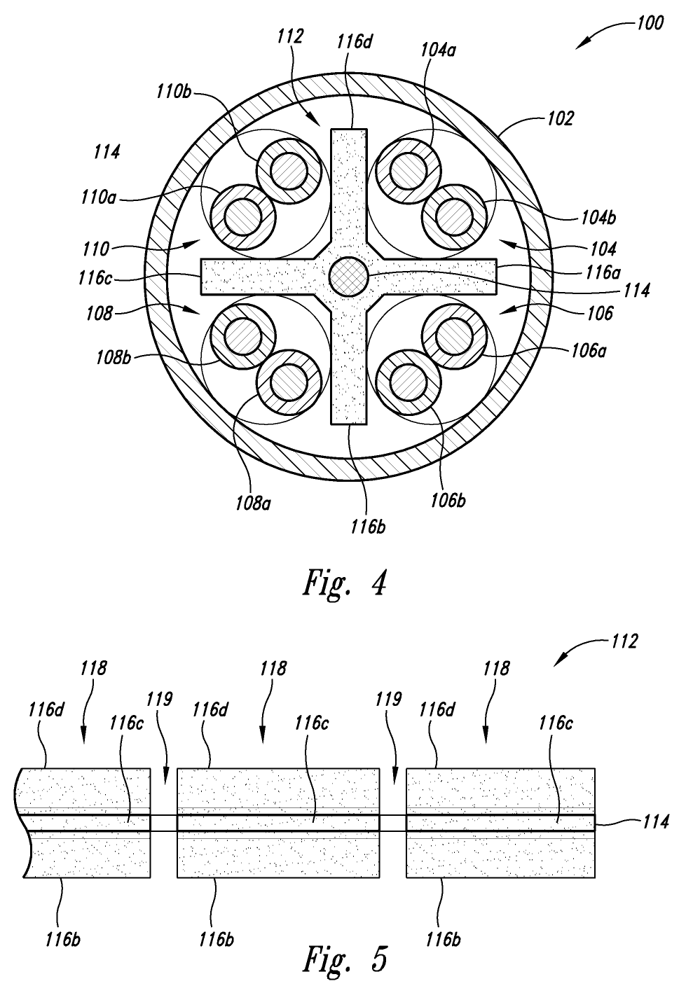

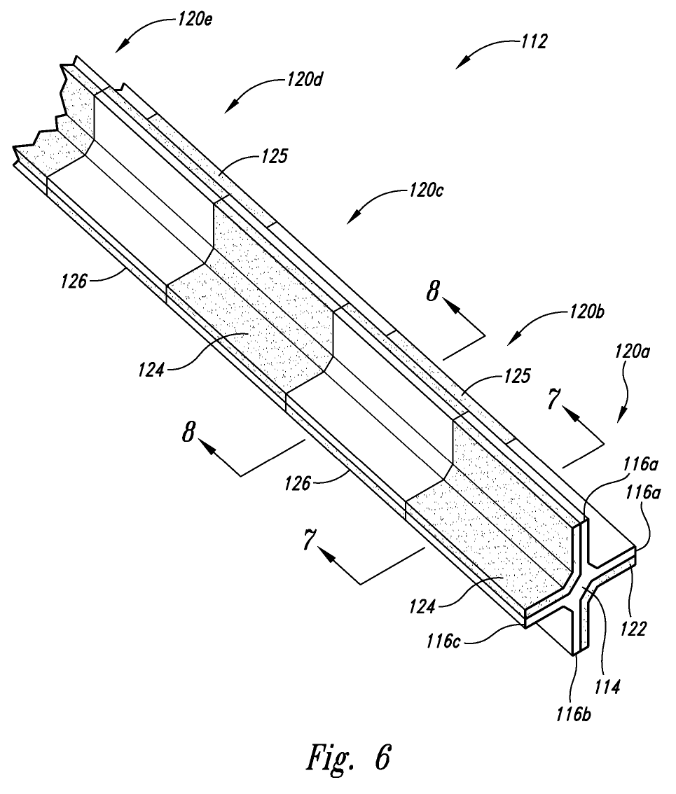

A second implementation of the shielding separator 112 is shown in FIGS. 4-5 in which the elongated center member 114 is of non-conductive material (as indicated in the Figures by hatched marking) and the elongated dividing members 116 are made from electromagnetic shielding material. The elongated center member 114 is shown in FIG. 5 as being continuous whereas the elongated dividing members 116 are shown to be part of divider sections 118 separated by gaps 119. In the second implementation, the conductive material is not one continuous length to prevent the shielding separator 112 from resonating like an antenna at frequencies such as from 1 MHz to 1 GHz.

Although the divider sections 118 are separated by gaps 119, the elongated non-conductor center member 114 allows the shielding separator 112 to remain as a continuous piece for ease of handling. As with the first implementation, the elongated center member 114 and the elongated dividing members 116 can be co-extruded to form co-extruded member portions of a single member with the elongated center member and the elongated dividing members being formed as an integral unit. Alternatively, other assembly techniques can be used such as cutting the elongated dividing members 116 into the divider sections 118 during assembly.

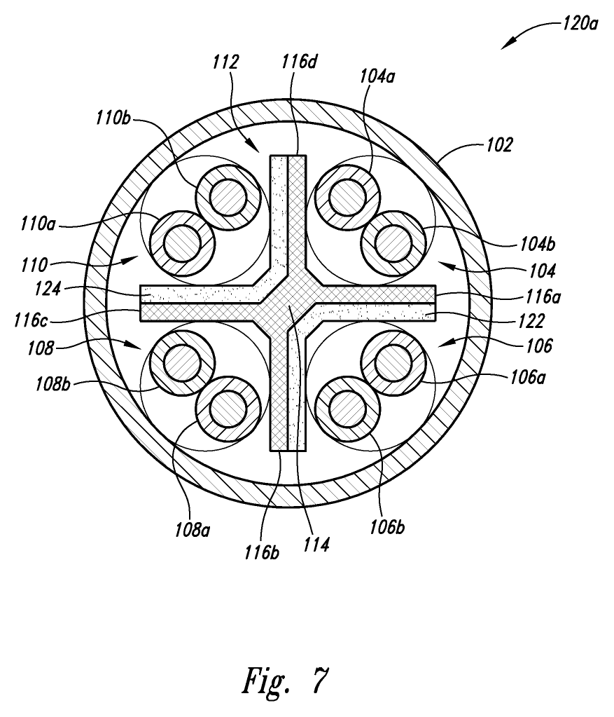

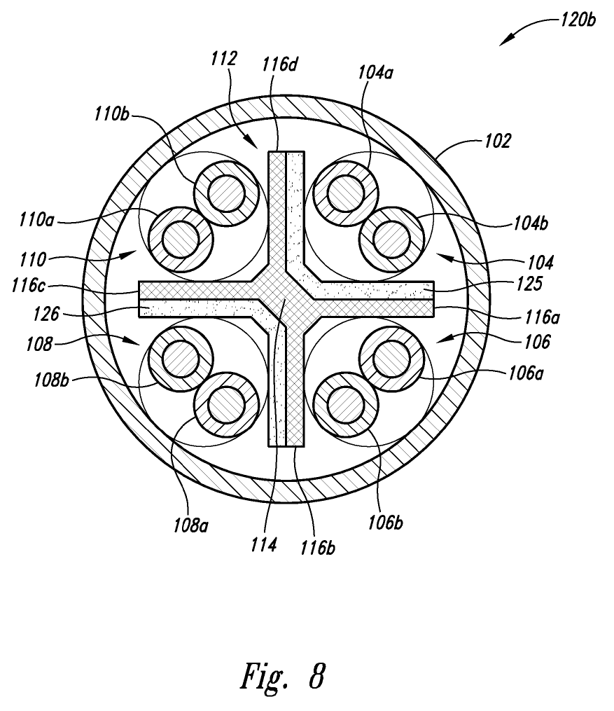

A third implementation of the shielding separator 112 is shown in FIGS. 6-8 as having the elongated center member 114 and the dividing members 116 made from a non-conductive material such as non-conductive plastic. The shielding separator 112 is divided into sections 120(a-e) as shown in FIG. 6 to include a first section 120a, a second section 120b, a third section 120c, a fourth section 120d, and a fifth section 120e in end to end relation with other possible sections not shown. The first section 120a of the shielding separator 112, shown in cross section in FIG. 7, has a conductive material layer 122 positioned adjacent the first elongated divider 116a and the second elongated divider 116b facing the second wire pair 106 to reduce interference between the second wire pair and the first wire pair 104, between the second wire pair and the third wire pair 108, and between the second wire pair and the fourth wire pair 110.

The first section 120a of the shielding separator 112 also has a conductive material layer 124 positioned adjacent the third elongated divider 116c and the fourth elongated divider 116d facing the fourth wire pair 110 to reduce interference between the fourth wire pair and the first wire pair 104, between the fourth wire pair and the second wire pair 106, and between the fourth wire pair and the third wire pair 108. Neither the conductive material layer 122 nor the conductive material layer 124 substantially shield from interference occurring between the first wire pair 104 and the third wire pair 108 since there is limited conductive material therebetween. As depicted, the elongated center member 114 has a greater dimensional width between the first wire pair 104 and the third wire pair 108 than the dimensional width between the second wire pair 106 and the fourth wire pair 110 to compensate for this lack of conductive material between the first wire pair and the third wire pair.

The second section 120b of the shielding separator 112, shown in cross section in FIG. 8, has a conductive material layer 125 positioned adjacent the first elongated divider 116a and the fourth elongated divider 116d facing the first wire pair 104 to reduce interference between the first wire pair and the second wire pair 106, between the first wire pair and the third wire pair 108, and between the first wire pair and the fourth wire pair 110.

The second section 120b of the shielding separator 112, shown in cross section in FIG. 8, also has a conductive material layer 126 positioned adjacent the second elongated divider 116b and the third elongated divider 116c facing the third wire pair 108 to reduce interference between the third wire pair and the first wire pair 104, between the third wire pair and the second wire pair 106, and between the third wire pair and the fourth wire pair 110. Neither the conductive material layer 125 nor the conductive material layer 126 substantially shield from interference occurring between the second wire pair 106 and the fourth wire pair 110 since there is limited conductive material therebetween. As depicted, the elongated center member 114 has a greater dimensional width between the second wire pair 106 and the fourth wire pair 110 than the dimensional width between the first wire pair 104 and the third wire pair 108 to compensate for this lack of conductive material between the second wire pair and the fourth wire pair.

The adjacent sections of the shielding separator 112 alternate in use of construction with the first and second sections 120a and 120b. For example as shown in FIG. 6, the third section 120c and the fifth section 120e have the conductive material layer 122 and the conductive material layer 124 positioned and the elongated center member 114 shaped as described above for the first section 120a and the fourth section 120d has the conductive material layer 125 and the conductive material layer 126 positioned and the elongated center member 114 shaped as described above for the second section 120b. The sections 120 are positioned in the shielding separator 112 as described to have sections with the conductive material layer 122 and the conductive material layer 124 alternating with the sections having the conductive material layer 125 and the conductive material layer 126. This is another way for the conductive material to be other than one continuous length to prevent the shielding separator 112 from resonating like an antenna at frequencies such as 1 MHz to 1 GHz.

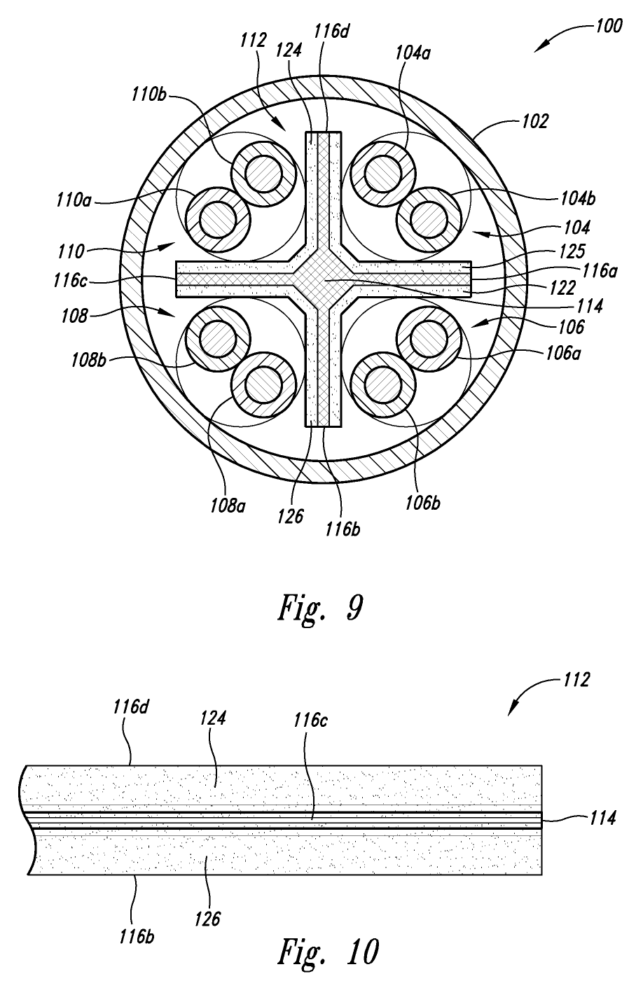

A fourth implementation of the shielding separator 112 is shown in FIGS. 9-10 as having the elongated center member 114 and the dividing members 116 being made from a non-conductive material such as non-conductive plastic. The shielding separator 112 further includes the conductive material layer 122, the conductive material layer 124, the conductive material layer 125, and the conductive material layer 126 positioned with respect to the elongated dividing members 116 as described above for section 120a (shown in FIG. 7) and section 120b (shown in FIG. 8), respectively.

In the fourth implementation, the conductive material layers 122, 124, 125 and 126 are not alternatively positioned, but are continuous along the length of the elongated dividing members 116. Since all four of the conductive material layers are present at any given portion of the shielding separator 112, the elongated center member 114 can be symmetrically shaped without need for one dimensional width between the first wire pair 104 and the third wire pair 108 being different from the dimensional width between the second wire pair 106 and the fourth wire pair 110.

The fourth implementation is similar to the first implementation since in both, the conductive materials used are continuous through the dimensional length, L, of the cabling system 100. A variation of the fourth implementation can be similar to the second implementation in that the conductive materials are divided into sections and separated by gaps or non-conductive material in order to prevent the shielding separator 112 from resonating like an antenna at frequencies such as 1 MHz to 1 GHz.

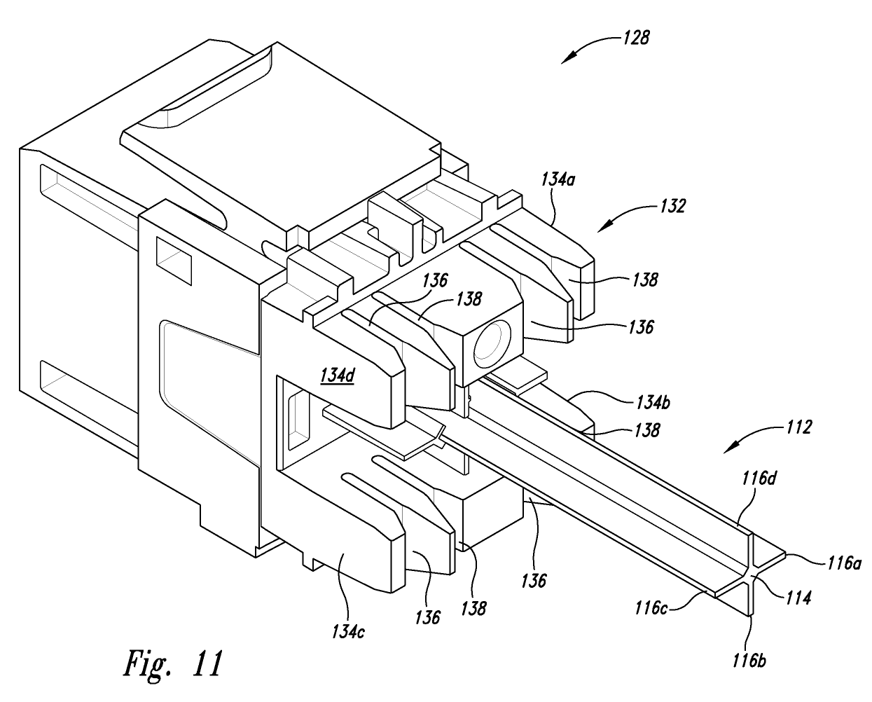

An example of the shielding separator 112 used in another context is shown in FIG. 11 where the shielding separator is engaged with a connector jack 128 in the vicinity of a wire pair coupling end 132 of the connector jack where the wire pairs 103 can be coupled to the connector jack. As shown, the coupling end 132 has a first coupling portion 134a, a second coupling portion 134b, a third coupling portion 134c, and a fourth coupling portion 134d, each having a first wire slot 136 and a second wire slot 138 to receive wires, as an example, for the first wire pair 104, the second wire pair 106, the third wire pair 108, and the fourth wire pair 110, respectively. The shielding separator 112 in FIG. 11 is depicted as having the construction of the first implementation described above, but other versions can use other of the implementations of the shielding separator.

From the foregoing it will be appreciated that, although specific embodiments of the invention have been described herein for purposes of illustration, various modifications may be made without deviating from the spirit and scope of the invention. Accordingly, the invention is not limited except as by the appended claims.

The invention claimed is:

1. A shielding separator for inclusion in a communication cabling, the communication cabling including a plurality of wires, the shielding separator comprising:
an elongated center member extending along a dimensional length; and
a plurality of elongated dividing members each extending along the dimensional length, each extending from the elongated center member, each having at least a portion being of an electrically conductive material, and each positionable within the communication cabling to be between at least two of the plurality of wires.

2. The shielding separator of claim 1 wherein the elongated center member is of an electrically non-conductive material.

3. The shielding separator of claim 2 wherein each of the plurality of elongated dividing members includes sections, each section being spaced apart from each adjacent section along the dimensional length by a gap.

4. The shielding separator of claim 3 wherein the elongated center member extends continuously along the dimensional length.

5. The shielding separator of claim 1 wherein each of the plurality of elongated dividing members radially extend from the elongated center member.

6. The shielding separator of claim 5 wherein the plurality of elongated dividing members extend from the elongated center member to form an “X” pattern.

7. The shielding separator of claim 1 wherein the elongated center member and all portions of the plurality of the elongated dividing members are of an electrically conductive material.

8. The shielding separator of claim 1 wherein the elongated center member is of an electrically conductive material.

9. The shielding separator of claim 1 wherein the electrically conductive material is an electrically conductive plastic.

10. The shielding separator of claim 9 wherein the electrically conductive plastic is an extruded plastic impregnated with metal fibers.

11. The shielding separator of claim 1 wherein the elongated center member and the elongated dividing members are formed as an integral unit.

12. The shielding separator of claim 1 wherein the elongated center member and the elongated dividing members are co-extruded member portions of a single member.

13. A shielding separator for inclusion in a communication cabling, the communication cabling including a plurality of wires, the shielding separator comprising:
an elongated center member extending along a dimensional length;
a plurality of elongated dividing members each extending along the dimensional length, each extending from the elongated center member, and each positionable within the communication cabling to be between at least two of the plurality of wires; and
a first electrically conductive material layer being adjacent to at least a portion of at least one of the elongated dividing members.

14. The shielding separator of claim 13 wherein the first electrically conductive material layer is an electrically conductive plastic.

15. The shielding separator of claim 14 wherein the electrically conductive plastic is an extruded plastic impregnated with metal fibers.

16. The shielding separator of claim 13 wherein the first electrically conductive material layer is adjacent to at least a portion of a first and at least a portion of a second of the elongated dividing members, the first electrically conductive material layer continuously extending between the first and second elongated dividing members.

17. The shielding separator of claim 16 further including a second electrically conductive material layer being adjacent to at least a portion of a third and at least a portion of a fourth of the elongated dividing members, the second electrically conductive material layer continuously extending between the third and the fourth elongated dividing members.

18. The shielding separator of claim 17 wherein the first and second electrically conductive material layers are an electrically conductive plastic.

19. The shielding separator of claim 18 wherein the electrically conductive plastic is an extruded plastic impregnated with metal fibers.

20. The shielding separator of claim 17 wherein a first lengthwise section of the shielding separator has only the first electrically conductive material layer and a second lengthwise section of the shielding separator has only the second electrically conductive material layer.

21. The shielding separator of claim 13 wherein the elongated center member is of an electrically non-conductive material.

22. The shielding separator of claim 21 wherein the elongated center member extends continuously along the dimensional length.

23. The shielding separator of claim 13 wherein each of the plurality of elongated dividing members radially extend from the elongated center member.

24. The shielding separator of claim 13 wherein the plurality of elongated dividing members extend from the elongated center member to form an “X” pattern.

25. The shielding separator of claim 13 wherein the elongated center member and the elongated dividing members are formed as an integral unit.

26. The shielding separator of claim 13 wherein the elongated center member and the elongated dividing members are co-extruded member portions of a single member.

27. A communication cabling comprising:
a sheathing having a dimensional length;
an elongated center member extending along the dimensional length being covered by the sheathing;
a plurality of elongated dividing members each extending along the dimensional length, each extending from the elongated center member, and each having at least a portion being of an electrically conductive material; and
a plurality of wire pairs being covered by the sheathing and being separated from one another by the elongated dividing members.

28. The communication cabling of claim 27 wherein the elongated center member is of an electrically non-conductive material.

29. The communication cabling of claim 28 wherein each of the plurality of elongated dividing members includes sections, each section being spaced apart from each adjacent section along the dimensional length by a gap.

30. The communication cabling of claim 27 wherein each of the plurality of elongated dividing members radially extend from the elongated center member.

31. The communication cabling of claim 27 wherein the plurality of elongated dividing members extend from the elongated center member to form an “X” pattern.

32. The communication cabling of claim 27 wherein the elongated center member and all portions of the plurality of elongated dividing members are of an electrically conductive material.

33. The communication cabling of claim 27 wherein the elongated center member is of an electrically conductive material.

34. The communication cabling of claim 33 wherein the electrically conductive material is an electrically conductive plastic.

35. The communication cabling of claim 34 wherein the electrically conductive plastic is an extruded plastic impregnated with metal fibers.

36. The communication cabling of claim 27 wherein the elongated center member and the elongated dividing members are formed as an integral unit.

37. The communication cabling of claim 27 wherein the elongated center member and the elongated dividing members are co-extruded member portions of a single member.

38. A communication cabling comprising:
a sheathing having a dimensional length;
an elongated center member extending along a dimensional length being covered by the sheathing;
a plurality of elongated dividing members each extending along the dimensional length, and each extending from the elongated center member;
a first electrically conductive material layer being adjacent at least a portion of at least one of the elongated dividing members; and
a plurality of wire pairs being covered by the sheathing and being separated from one another by the elongated dividing members.

39. The communication cabling of claim 38 wherein the first electrically conductive material layer is an electrically conductive plastic.

40. The communication cabling of claim 39 wherein the electrically conductive plastic is an extruded plastic impregnated with metal fibers.

41. The communication cabling of claim 38 wherein the first electrically conductive material layer is adjacent to at least a portion of a first and at least a portion of a second of the elongated dividing members, the first electrically conductive material layer continuously extending between the first and second elongated dividing members.

42. The communication cabling of claim 41 further including a second electrically conductive material layer being adjacent to at least a portion of a third and at least a portion of a fourth of the elongated dividing members, the second electrically conductive material layer continuously extending between the third and the fourth elongated dividing members.

43. The communication cabling of claim 42 wherein the first and second electrically conductive material layers are an electrically conductive plastic.

44. The communication cabling of claim 43 wherein the electrically conductive plastic is an extruded plastic impregnated with metal fibers.

45. The communication cabling of claim 42 wherein a first section of the shielding separator has only the first electrically conductive material layer and a second section of the shielding separator has only the second electrically conductive material layer.

46. The communication cabling of claim 38 wherein the elongated center member is of an electrically non-conductive material.

47. The communication cabling of claim 38 wherein each of the plurality of elongated dividing members radially extend from the elongated center member.

48. The communication cabling of claim 47 wherein the plurality of elongated dividing members extend from the elongated center member to form an “X” pattern.

49. The communication cabling of claim 38 wherein the elongated center member and the elongated dividing members are formed as an integral unit.

50. The communication cabling of claim 38 wherein the elongated center member and the elongated dividing members are co-extruded member portions of a single member.

51. A connector comprising:
a coupling end for receiving cabling wires;
an elongated center member extending along a dimensional length from the coupling end; and
a plurality of elongated dividing members each extending along the dimensional length, each extending from the elongated center member, each having at least a portion being of an electrically conductive material, and each positionable to be between at least two of the cabling of wires.

52. A connector comprising:
a coupling end for receiving cabling wires;
an elongated center member extending along a dimensional length from the coupling end;
a plurality of elongated dividing members each extending along the dimensional length, each extending from the elongated center member, and each positionable to be between at least two of the cabling of wires; and
a first electrically conductive material layer being adjacent at least a portion of at least one of the elongated dividing members.
